(19) United States
(12) Patent Application Publication
(10) Pub. No.: US 2003/0145320 A1
(43) Pub. Date: Jul. 31, 2003

(54) Commercial detector

(76) Inventor: Peter Vogel, Faulconbridge, NSW (AU)

Correspondence Address: FISH & RICHARDSON, PC, 4350 LA JOLLA VILLAGE DRIVE, SUITE 500, SAN DIEGO, CA, 92122, US

(21) Appl. No.: 10/220,909

(22) PCT Filed: Mar. 7, 2001
(86) PCT No.: PCT/AU01/00244

(30) Foreign Application Priority Data
Mar. 8, 2000 (AU) PQ 6090

(51) Int. Cl. H04N 7/16; H04H 9/00; H04N 5/91

(52) U.S. Cl. 725/22; 725/32

(57) ABSTRACT

The invention detects commercials interrupting television programs by comparing signals in a comparator (16) received from multiple regions (1, 6, 11) of a network. If one or more of the received signals differs from the other received signals by more than a preset amount, generating a signal via output (17) indicating the presence of a commercial. Because different commercials are inserted in different regions of a network, the signals are generally very similar during program transmission and very different during commercial transmission.

### FIELD OF THE INVENTION

The present invention relates to systems for detecting television or radio commercials.

### BACKGROUND OF THE INVENTION

Many systems have been proposed for detecting commercials or other unwanted material within television or radio programs, as such systems are required for applications such as editing out commercials, logging broadcast times of commercials for analytical purposes, recording commercials for quality control and so on.

One effective system for detecting commercials is described in U.S. Pat. No. 5,371,795to Vogel which is hereby incorporated by reference for all purposes. In Vogel's system, a number of people monitor broadcasts as they go to air. These people then enter data into a computer as the content of a channel changes. When a commercial starts on a particular channel, the monitoring person presses a button that causes a signal to be transmitted to viewers' homes indicating that a commercial is in progress on the channel concerned. Equipment at the viewer's home recognises this signal, and if the channel indicated by the signal is being viewed or recorded, the television receiver or video recorder is disabled until the commercial break is finished, as indicated by receipt of another signal constituted for this purpose.

Other systems, such as pattern recognition systems that recognise commercials, can also be utilized with good results. Many systems of this type, however, are complex and expensive. Many prior art commercial detectors also suffer high error rates, rendering them almost useless, particularly if the nature of the error is such that material which is not a commercial is incorrectly recognised as a commercial and eliminated from a recording.

### SUMMARY OF THE INVENTION

It is an object of this invention to provide a system and process which detects commercials within television or radio programs with a high degree of accuracy. Another object of the invention is to provide a commercial detection system in which the predominant failure mode results in inclusion of commercials, rather than exclusion of non-commercial program material.

In one aspect, the present invention provides a commercial detecting method comprising the steps of receiving a broadcast program from a plurality of receivers, comparing the received programs, and if one or more of the received program signals differs from the other received program signals by more than a preset amount, generating a signal indicating presence of a commercial.

In another aspect of the invention, each of the plural receivers receive a broadcast program from a different geographical area.

According to yet another aspect, the comparison step includes the sub-step of allowing for time delays between the plural signals received.

In yet another aspect, the present invention provides a commercial detector comprising a plurality of program receivers and comparator means, said comparator means being adapted to compare the programs received by the receivers and, if at least one of the programs differs from another received program by more than a preset threshold, generate a signal indicating presence of a commercial.

In yet another aspect, the present invention provides a commercial detector comprising a plurality of program receivers disposed at different geographical regions so that the programs received by each originate from different sections of a broadcast network, and comparator means located at a central office, said comparator means being adapted to compare the programs received by the receivers and, if at least one of the programs differs from another received program by more than a preset threshold, generate a signal indicating presence of a commercial.

In some embodiments the invention may further comprise data reduction means located at the receivers so that the bandwidth of the data conveyed to the central office is reduced.

In yet another aspect, the present invention provides a commercial detector comprising a plurality of program receivers arranged to receive programs intended for reception in different sections of a broadcast network, and comparator means, said comparator means being adapted to compare the programs received by the receivers and, if at least one of the programs differs from another received program by more than a preset threshold, generate a signal indicating presence of a commercial. For example, in the aspect the receivers of the invention may comprise satellite receivers arranged to receive programs which are being relayed by satellite to different geographical regions.

According to yet another aspect, the comparator means is adapted to allow for time delays between the plural signals received.

In another aspect, the invention is further adapted to be responsive to television schedule data so that only programs received from regions where the same program is being broadcast are compared. The invention can be further adapted so that commercial recognition is inhibited at times when different programs are being broadcast in all regions being received, in which circumstance commercials cannot be recognised by comparison of received signals.

According to yet another aspect, the invention further comprises memory means and a controller adapted to store data representative of a commercial when a commercial is detected by the comparison method of this invention, and to compare this stored data to received signals for detecting commercials at times when commercials cannot be detected by comparing programs being broadcast or when identical commercials are broadcast in the regions being compared.

### DESCRIPTION OF PREFERRED EMBODIMENTS

Embodiments of the invention will now be described with reference to the drawings in which:

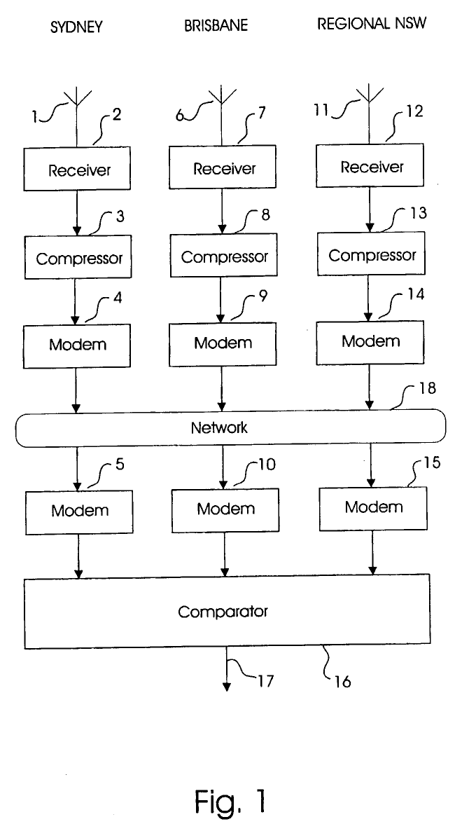

FIG. 1 is a block diagram of an embodiment of the present invention utilizing three television receivers in remote locations;

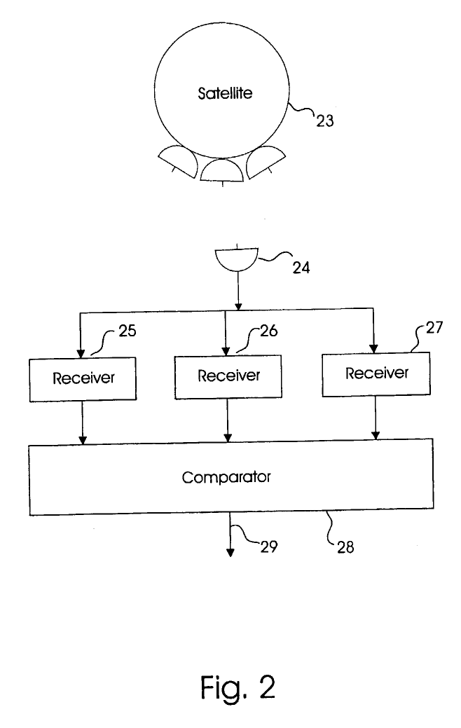

FIG. 2 is a block diagram of an embodiment of the invention utilising three satellite receivers located locally.

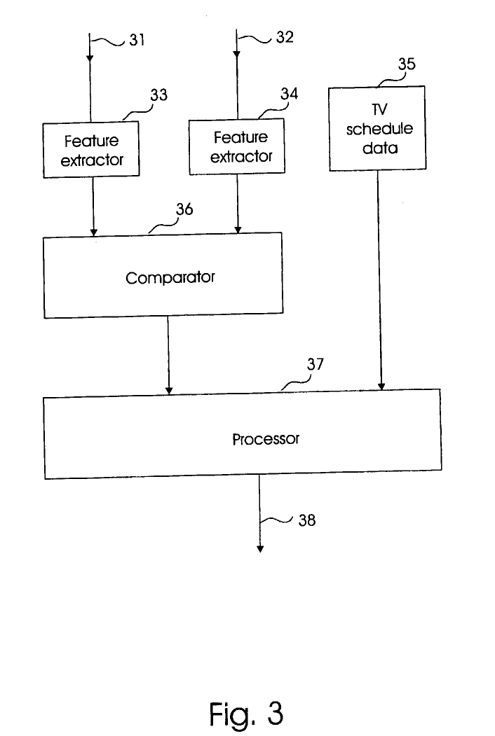

FIG. 3 is a block diagram of an embodiment of the invention in which television schedule data is used to determine when program comparison is a valid method of commercial detection; and

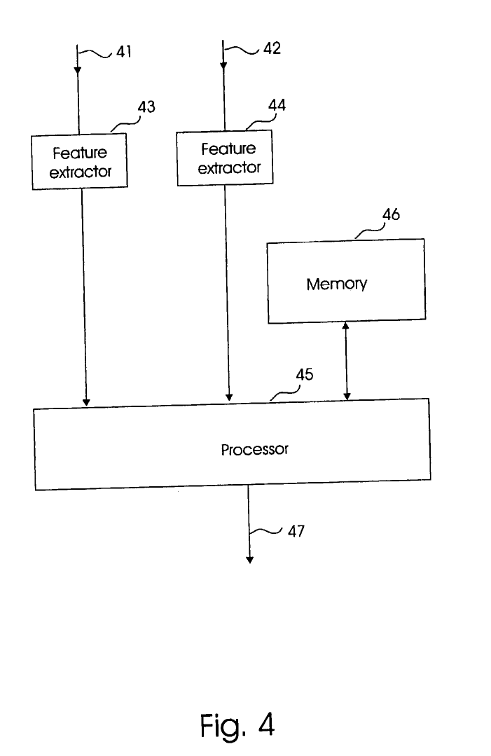

FIG. 4 is a block diagram of an embodiment of the invention in which signatures of commercials are stored in memory and used to recognise commercials when identical programs are not available for comparison.

Referring now to FIG. 1, this embodiment of the invention utilises three receivers which are located in three different geographical areas. The locations are chosen so that each receiver receives a network program from a different region. It is usual television network practice to insert local advertising into programs in each region, with the result that the signal received by each receiver will be substantially the same during program segments, but during commercial breaks the different commercials will result in at least one of the receivers receiving different material. This difference is used by the invention to detect the commercial.

To assist in understanding the operation of this embodiment of the invention, the example of a television network covering Sydney, Brisbane and regional NSW will be used. Considering the operation of the receiving section of the invention in the Sydney region only, receiver 2 receives local television broadcasts via antenna 1.

The signal is compressed by compressor 3, which reduces the bandwidth of the picture and/or sound sufficiently to allow transmission via telephone, internet or similar network. Many well-known techniques, such as those developed for teleconferencing or Internet video streaming, can be employed by the compressor. Dramatic loss of detail can be tolerated since the objective is only to provide a video or audio signal sufficient for comparison to another signal; the signal need not be watchable.

The compressed signal is transmitted by modem 4 via network 18 to modem 5. Network 18 in this embodiment is the PSTN although other networks such as the internet can also be used. Modem 5 receives the compressed program and forwards the demodulated data to comparator 16.

Comparator 16 also receives the compressed signals from Brisbane and regional NSW via modems 10 and 15 respectively. These signals are sourced via antenna 6, receiver 7, compressor 8 and modem 9 in Brisbane and antenna 11, receiver 12, compressor 13 and modem 14 in regional NSW.

Comparator 16 in this embodiment comprises a computer fitted with three serial data ports to receive data from modems 5, 10, and 15. Software is provided to continuously process the three received compressed broadcast signals and compare the picture and sound. To reduce the complexity of the system, either the sound or picture content of the broadcast can be ignored, however reliability and speed of recognition of commercials will be compromised to some degree.

Due to the mechanisms typically used for distribution of network television, there is normally a small time delay between broadcasts in different regions. Where satellite distribution is used, there is typically a few hundred milliseconds time delay between broadcasts in different regions. To allow for such delays, the software of comparator 16 uses correlation techniques as well as simple comparisons. In this embodiment, each incoming program source is examined over a sliding window of plus/minus one second, looking for maximum correlation with the other two regions. When the broadcast in all three regions is of the same program material, the correlation between the three regions will exceed a preset threshold, and the output 17 of comparator 16 indicates program material. When a commercial break occurs and the commercial say Brisbane is different from the commercial in Sydney and regional NSW, the correlation between Brisbane and the other two regions will be very low, and the output 15 of comparator 14 will indicate commercial material.

Referring now to FIG. 2, a second embodiment of the invention is shown, in which the three receivers for the different regions are placed in the same location. This system is useful in cases where distribution of network programming to different regions is accomplished by satellite. In this case, the three receivers are tuned to receive the downlinks destined for different regions of the network. These may be from the one satellite, or multiple satellites. The advantage of this arrangement is that all the equipment of the invention can be located in the one place, and the communications network required by the arrangement of FIG. 1 is not required.

TV satellite 23 distributes network programs to several regions. Antenna 24 conveys these programs to receivers 25, 26 and 27 which are tuned to decode the programs intended for the various regions, which include common program material and regionalised commercial material. Comparator 28 compares these signals as described in relation to the embodiment of FIG. 1 above, outputting a signal indicating the presence of program material or commercial material at output 29.

In some cases network programming is delayed by long periods in some regions, for example to compensate for timezone or daylight saving differences. The invention can be adapted to work under such circumstances by providing a fixed delay in the data path of one or more program sources. Such a delay, which will usually be in integer multiples of one hour, can be incorporated into the software of the comparator, or provided elsewhere.

Referring now to FIG. 3, a further variation of the invention will be described. In this embodiment, television signals are received from different regions of a network via inputs 31 and 32, which feed feature extractors 33 and 34 respectively. In this example, the feature extractors reduce the picture to 64 pixels of greyscale and sample the audio envelope 10 times per second, providing low bandwidth data output to comparator 36. Comparator 36 includes a correlator which compensates for any time delay between the inputs 31 and 31. The output of comparator 36 therefore indicates whether the signals are the same or not. An indication that the signals are not the same can indicate that a commercial is in progress, but only if the program being broadcast in each region from which inputs 31 and 32 are sourced is the same. So that commercial detection does not occur erroneously when different programs are being broadcast, as opposed to different commercials, processor 37 receives the output of comparator 36 as well as TV schedule data stored in memory 35. Processor 37 is programmed to compare the programs scheduled for broadcast in each of the regions from which signals are being sourced, taking into account the current time and date. If the same program is scheduled in both regions being received, comparator output indicating significant difference is used to indicate a commercial in progress. Otherwise, commercial recognition is not attempted.

Referring now to FIG. 4, a further adaptation of the invention is described wherein commercial recognition is possible even when different programs or identical commercials are being broadcast in the regions being monitored.

In this embodiment, signals from two regions of a network are received by inputs 41 and 42, which feed feature extractors 43 and 44 respectively. The feature extrators in this exemplary embodiment operate as described in relation to FIG. 3 above. The outputs of feature extractors 43 and 44 feed inputs of processor 45. Processor 45 is arranged to correlate the inputs from the feature extractors. When a close match between the two signals is detected and sustained for a predetermined period, in this example 7 minutes, processor 45 considers the two received signals to be program material. When correlation subsequently ceases, processor 45 considers the signals being received to be conmmercials. Output 47 is then activated, indicating commercial detection, and the feature data from both feature extractors is stored in memory 46.

In this way, a library of data sets corresponding to features of commercials is automatically accumulated in memory 46.

Subsequently, processor 45 uses feature data read from memory 46 as a third input to its correlation/recognition process, so that in cases where identical commercials or different programs are broadcast in both regions being monitored, commercials can be recognised by correlation with previously-stored data from memory 46.

It is of course possible to combine aspects of the above-described exemplary embodiments with good effect. For example, adding the TV schedule feature of FIG. 3 to the system of FIG. 4 yields a system which knows when the same program can be expected to be received in both regions being monitored, so that non-correlating signals can be assumed with high confidence to be commercials. Similarly, when different programs are scheduled, correlation of both received signals with the features previously stored in memory 46 can be automatically selected to allow high-accuracy commercial recognition to continue.

It will be understood that the foregoing represents only particular embodiments of the invention, and many changes can be made without departing from the scope of the invention.

Whereas the comparator of the invention is described a performing a correlation between compressed sound and/or vision components of the program, many other techniques can be employed for comparing the content of regional broadcasts with good results. For example, the overall sound envelope can be compared at a relatively low rate, say 10 times per second, and trends in this value compared. Alternatively, particular regions of the picture can be isolated for comparison, reducing the bandwidth requirements dramatically. A combination of techniques such as these can be employed to provide a simple, low bandwidth system with high accuracy.

The commercial recognition techniques of the present invention can also be combined with other methods of commercial detection to further improve utility. For example, manual monitoring can be used as a secondary detection level, so that if the system fails due to an identical commercial being broadcast in all monitored regions, a human operator can initiate a manual override. Other automatic recognition systems, such as pattern recognition schemes that are taught to automatically recognise particular commercials, can also be combined with the comparison techniques of this invention to provide a more versatile system.

1. A commercial detecting method comprising the steps of receiving a plurality of broadcast signals, comparing said received signals, and if one or more of the received signals differs from the other received signals by more than a preset amount, generating a signal indicating presence of a commercial.

2. A commercial detecting method comprising the steps of receiving a plurality of broadcast signals from at least two geographical areas, comparing said received signals, and if one or more of the received signals differs from the other received signals by more than a preset amount, generating a signal indicating presence of a commercial.

3. A commercial detecting method according to claim 2 wherein the step of comparing said received signals is performed at a central office and at least one of said received signals is received in a geographical location remote from said central office and communicated to said central office for comparison.

4. A commercial detecting method according to claim 1 wherein the step of receiving a plurality of broadcast signals is performed at a single geographical location and comprises the step of receiving signals at least one of which is customised for reception in specific geographic locations.

5. A commercial detecting method according to claims 1 to 4 in which the step of comparing said received signals includes the sub-step of compensating for time delays between the signals received.

6. A commercial detecting method according to claims 1 to 4 and further comprising the step of reducing the bandwidth of said received signals.

7. A commercial detecting method according to claims 1 to 4 in which the step of comparing said received signals includes the sub-step of receiving schedule information and comparing only received signals which, according to said schedule information, correspond to identical programs.

8. A commercial detecting method according to claims 1 to 4:
in which the step of comparing said received signals includes the sub-step of receiving schedule information and comparing only received signals which, according to said schedule information, correspond to identical programs; and
further comprising the step of inhibiting commercial detection if said received schedule information indicates that the same program is not scheduled to be broadcast at that time on at least two of said received signals.

9. A commercial detecting method according to claims 1 to 4 and further comprising the steps of:
storing in memory means data representative of a commercial when a commercial is detected; and
comparing said stored data to said received signals.

10. A commercial detecting method according to claims 1 to 4 and further comprising the steps of:
storing in memory means data representative of a commercial when a commercial is detected;
receiving broadcast schedule data; and
if said schedule data indicates that the same program is not scheduled to be broadcast at that time on at least two of said received signals:
comparing said stored data to said received signals.

11. A commercial detector comprising a plurality of broadcast signal receivers and a comparator adapted to compare said received signals and generate a signal indicating presence of a commercial if one or more of said received signals differs from the other received signals by more than a preset amount.

12. A commercial detector comprising a plurality of broadcast signal receivers, at least one of which receives a broadcast signal from a geographical area remote from the other receivers, and a comparator adapted to compare said received signals and generate a signal indicating presence of a commercial if one or more of said received signals differs from the other received signals by more than a preset amount.

13. A commercial detector according to claim 12 wherein said comparator is located at a central office and at least one of said receivers is located in a geographical location remote from said central office and further comprising means for communicating signals received at said remote location to said central office.

14. A commercial detector according to claim 11 wherein said broadcast signal receivers are located at a single geographical location and at least one of said receivers is adapted to receive signals customised for reception in specific geographic locations.

15. A commercial detector according to claims 11 to 14 and further comprising means for compensating for time delays between the signals received.

16. A commercial detector according to claims 11 to 14 and further comprising means for reducing the bandwidth of said received signals.

17. A commercial detector according to claims 11 to 14 further comprising means for receiving schedule information and in which said comparator is further adapted to compare only received signals which, according to said received schedule information, correspond to identical programs.

18. A commercial detector according to claims 11 to 14 further comprising means for receiving schedule information and in which said comparator is further adapted to:
compare only received signals which, according to said received schedule information, correspond to identical programs; and
inhibit commercial detection if said received schedule information indicates that the same program is not scheduled to be broadcast at that time on at least two of said received signals.

19. A commercial detector according to claims 11 to 14 further comprising:
memory means;
a controller adapted to store data representative of a commercial in said memory means when a commercial is detected; and
means for comparing said stored data to said received signals.

20. A commercial detector according to claims 11 to 14 further comprising:
memory means;
means for receiving broadcast schedule data; and
processor means adapted to store data representative of said received program signals in said memory means when two of said received signals are different and said broadcast schedule data indicates that the programs represented by the two received signals are scheduled to be the same.

21. A commercial detector according to claims 11 to 14:
further comprising:
memory means;
means for receiving broadcast schedule data;
processor means adapted to store data representative of said received program signals in said memory means when two of said received signals are different and said broadcast schedule data indicates that the programs represented by the two received signals are scheduled to be the same; and
wherein said comparator is further adapted to compare said stored data with said received signals.

22. A commercial detector according to claims 11 to 14 further comprising:
memory means containing stored data representative of commercials;
means for receiving broadcast schedule data; and
processor means adapted to compare said stored data with said received signals when said broadcast schedule data indicates that the programs represented by the received signals are scheduled to be different.

23. A commercial detector substantially as hereinbefore described, with reference to the accompanying drawings.

24. A commercial detecting method substantially as hereinbefore described, with reference to the accompanying drawings.
